(19) United States
(12) Patent Application Publication
(10) Pub. No.: US 2007/0142200 A1
(43) Pub. Date: Jun. 21, 2007

(54) Glass and optical glass element

(76) Inventors: Toshiharu Mori, Osaka (JP); Akio Oogaki, Itami-shi (JP); Yoshihiro Kamada, Osaka (JP)

Correspondence Address: BRINKS HOFER GILSON & LIONE, P.O. BOX 10395, CHICAGO, IL, 60610, US

(21) Appl. No.: 11/603,918

(22) Filed: Nov. 22, 2006

(30) Foreign Application Priority Data
Nov. 25, 2005 (JP) JP 2005-340274

(51) Int. Cl. C03C 3/00

(52) U.S. Cl. 501/11

(57) ABSTRACT

Disclosed herein is a glass whose viscosity index (A) defined as a value obtained by dividing the viscosity of the glass at the liquidus temperature thereof by the liquidus temperature of the glass is in the range of 0.0004 to 1.5. Such a glass is melted in a melting furnace equipped with a nozzle, and the molten glass is dropped from the nozzle intermittently and regularly to obtain glass droplets. The glass droplet naturally dropped from the nozzle is received by a receiving mold to form a glass gob. The glass gob can be used as a preform for reheating molding. Further, it is possible to produce an optical glass element having no plane defect such as a shear mark by press-molding a hot glass gob with an upper mold just after the glass gob is received by the receiving mold.

The present application claims priority to Japanese Patent Application No. 2005-340274 filed Nov. 25, 2005, the entire content of which is hereby incorporated by reference.

### BACKGROUND OF THE INVENTION

1. Field of the Invention

The present invention relates to a glass from which glass droplets can be easily formed by melting the glass and discharging the molten glass from a nozzle. The present invention further relates to a glass preform and an optical glass element which are produced from the glass droplet.

2. Description of the Related Art

In the field of production of glass articles such as optical glass elements (e.g., lenses and prisms) by precision molding, the use of glass droplets naturally dropped by gravitation from a nozzle of a melting furnace has been studied.

As shown in FIG. 1a, when molten glass 10 discharged from a nozzle 2 of a melting furnace 1 is too soft (that is, the viscosity of the molten glass 10 is too low), a stream of the molten glass 10 continuously flows from the nozzle 2 like tap water. In this case, it is not possible to form glass droplets having a certain volume.

On the other hand, as shown in FIG. 1b, when the molten glass 10 discharged from the nozzle 2 of the melting furnace 1 is too hard (that is, the viscosity of the molten glass 10 is too high), it is necessary to cut the stream of the molten glass 10 with a cutting means 5 such as a blade or shears to form glass droplets. In this case, however, the obtained glass droplet has a defect called a “shear mark”.

Meanwhile, Japanese Patent Application Laid-open No. H8-277120 discloses a method for separating and cutting a stream of molten glass by rapidly lowering a receiving mold on which the lower end of the molten glass stream is received and supported.

In Japanese Patent Application Laid-open No. H8-277120, Table 1 shows the thermophysical properties such as liquidus temperature and the like and the viscosities of various glasses used in an experiment and experimental conditions. However, such thermophysical properties and viscosities of molten glasses used in an experiment shown in Table 1 in Japanese Patent Application Laid-open No. H8-277120 are merely experimental data because there is no description about technical implication of these data. Further, disclosed in Japanese Patent Application Laid-open No. H8-277120 is a method for forming by discharging glass droplets from a nozzle 2 and retaining one or more glass droplets in a receiving mold brought close to the nozzle 2, which is different from a method for forming by naturally dropping glass droplets.

### SUMMARY OF THE INVENTION

It is a main object of the present invention to provide a glass suitable for forming glass droplets by melting the glass and naturally dropping the molten glass intermittently and regularly from a nozzle of a melting furnace.

In order to achieve the above object and other objects, one aspect of the present invention is directed to a glass whose viscosity index (A) defined as a value obtained by dividing the viscosity of the glass at the liquidus temperature thereof by the liquidus temperature of the glass is in the range of 0.0004 to 1.5.

The invention itself, together with further objects and attendant advantages, will best be understood by reference to the following detailed description taken in conjunction with the accompanying drawings.

### BRIEF DESCRIPTION OF THE DRAWINGS

FIGS. 1a to 1c are schematic diagrams for explaining the relationship between the viscosity of a glass and how the glass is discharged from a nozzle, wherein FIG. 1a shows the case of a conventional glass whose viscosity is too low, FIG. 1b shows the case of a conventional glass whose viscosity is too high, and FIG. 1c shows the case of a glass according to the present invention; and

FIG. 2 is a diagram for explaining the relationship between temperature and viscosity of the glass.

In the following description, like parts are designated by like reference numbers throughout the several drawing.

### DETAILED DESCRIPTION OF THE PREFERRED EMBODIMENTS

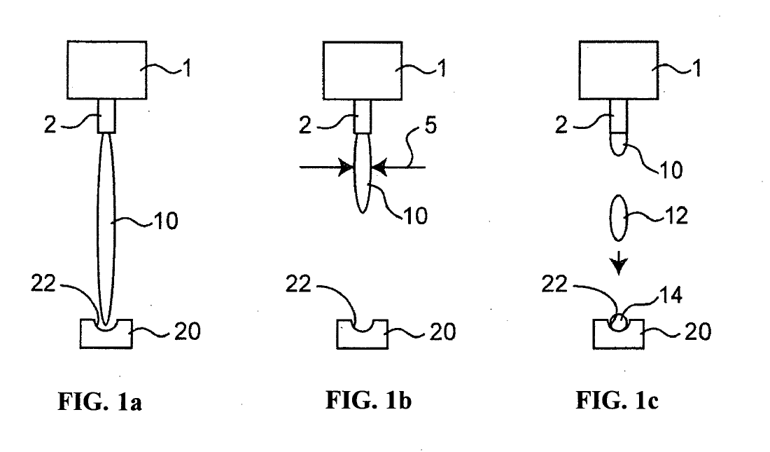

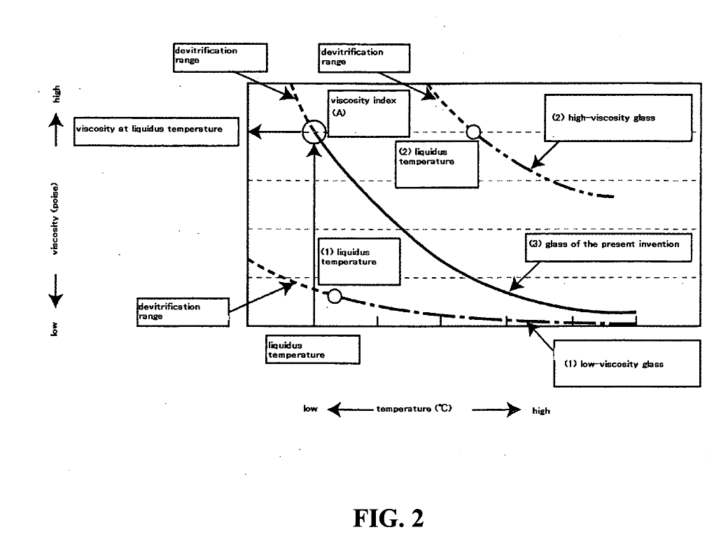

FIGS. 1a to 1c are schematic diagrams for explaining the relationship between the viscosity of molten glass 10 and how the molten glass 10 is discharged from a nozzle 2 of a melting furnace 1, wherein FIG. 1a shows the case of a conventional glass whose viscosity is too low, FIG. 1b shows the case of a conventional glass whose viscosity is too high, and FIG. 1c shows the case of a glass according to the present invention, and FIG. 2 is a diagram for explaining the relationship between temperature and viscosity of the molten glass 10. It is to be noted that in FIGS. 1a to 1c, components common to the conventional art and the present invention have the same reference numerals.

As shown in FIG. 1c, an apparatus for producing a glass gob 14 basically comprises a melting furnace 1 for melting glass, a nozzle 2 provided at the bottom of the melting furnace 1 to discharge molten glass out of the melting furnace 1, and a receiving mold 20 for receiving a glass droplet 12 which is formed at the tip of the nozzle 2 and is then naturally dropped from the nozzle 2.

The melting furnace 1 is equipped with a stirring rod to homogenize the molten glass 10. Although various types of molten glasses can be used for forming glass droplets, as will be described later, a glass having a predetermined viscosity index (A) is suitable for forming glass droplets. For example, in the case of producing optical glass elements, oxide glasses and fluoride glasses can be used.

The melting furnace 1 and the nozzle 2 are maintained at their respective predetermined temperatures by heaters. The glass droplets 12 are dropped at substantially regular intervals of time. The time interval between two successive glass droplets 12 dropped from the nozzle 2 can be more accurately controlled by providing a dropping sensor comprising a pair of a light emitter and a light receiver along a path of the glass droplets 12 to detect the pass of each glass droplet 12, sending a detection signal to a control section, and giving feedback to the heaters. It is to be noted that the time interval between two successive glass droplets 12 dropped from the nozzle 2 can be set to any value by changing a heating power of the heaters, but is preferably in the range of about 1 to 20 seconds for stable dropping.

The weight of each glass droplet is determined by the shape of the tip of the nozzle 2. From the viewpoint of obtaining a glass droplet 12 which is free from devitrification and which has weight stability and excellent internal quality, the internal diameter of the nozzle tip is ψ0.1 mm or more but ψ1 mm or less, preferably in the range of ψ0.3 mm to ψ0.8 mm, and the outer diameter of the nozzle tip is in the range of ψ2 mm to ψ15 mm, preferably in the range of ψ5 mm to ψ15 mm. By setting the internal diameter and the outer diameter of the nozzle tip to values within the above their respective ranges, it is possible to obtain a glass droplet 12 having a weight of 0.2 to 1.5 g. If the internal diameter of the nozzle tip is too small, the time interval between two successive glass droplets 12 dropped from the nozzle 2 becomes longer so that the retention time of the glass droplets 12 during production of a glass gob 14 becomes undesirably longer. On the other hand, if the internal diameter of the nozzle tip is increased to exceed the above upper limit value, it is difficult to obtain a glass droplet 12 because the force with which the molten glass flows from the nozzle 2 becomes greater than the surface tension of the molten glass so that the molten glass is likely to form a laminar flow. If the outer diameter of the nozzle tip is too small, the obtained glass droplet 12 becomes smaller so that the retention time of the glass droplets 12 during production of a glass gob 14 becomes undesirably longer. On the other hand, even if the outer diameter of the nozzle tip is increased to exceed the above upper limit value, the weight of the glass droplet 12 obtained by naturally dropping the molten glass is hardly increased because the glass droplet 12 is formed using the surface tension of the molten glass. It is to be noted that a preferred shape of the tip of the nozzle 2 has been described above by way of example, but the shape of the tip of the nozzle 2 is not limited thereto.

In the above description, the melting furnace and the nozzle are heated using a heater, but other heating means such as a high-frequency coil and an infrared lamp may alternatively be used. Particularly, high-frequency heating is effective at heating the melting furnace and the nozzle to a high temperature of 1,000° C. or higher.

When a stream of the molten glass 10 is discharged from the nozzle tip under strict temperature-controlled conditions in such a manner as described above, the lower end of the molten glass stream 10 is formed into a glass droplet 12 having a predetermined weight and then the glass droplet 12 is naturally dropped by its own weight. The glass droplet 12 naturally dropped is received by a concave molding surface 22 of the receiving mold 20 to form a glass gob 14. The receiving mold 20 is preferably located 10 to 50 cm below the nozzle 2.

The temperature of the receiving mold 20 may be room temperature, and therefore it is not particularly necessary to control the temperature of the receiving mold 20. However, if the temperature of the receiving mold 20 is too low, wrinkles are likely to be generated in the glass gob 14. In order to prevent the generation of wrinkles, high-temperature control of the receiving mold 20 with a heating means is effective. More specifically, the temperature of the receiving mold 20 is controlled in the vicinity of the glass transition point (Tg) to prevent reaction with the molten glass. Further, when the nozzle tip has a closed portion filled with a non-oxidative gas such as nitrogen or argon, reaction between the glass gob 14 and the receiving mold 20 is suppressed. In this case, the glass gob 14 can be received by the receiving mold 20 controlled at a higher temperature.

Examples of a material of the receiving mold 20 include ceramic materials, cemented carbides, carbon materials, and metallic materials. Among them, from the viewpoint of high heat conductivity and low reactivity with glass, carbon materials and ceramic materials are preferably used.

As described above, the molten glass 10 is cut into droplets by its own weight and viscosity, and therefore the obtained glass gob 14 has no shear mark (cut mark) and no striae or devitrification but has weight stability.

Next, the relationship between the temperature of the molten glass 10 and the viscosity of the molten glass 10 will be described with reference to FIG. 2.

In FIG. 2, the conventional glass whose viscosity in the molten state is too low is indicated by the mark “(1)”, the conventional glass whose viscosity in the molten state is too high is indicated by the mark “(2)”, the glass according to the present invention is indicated by the mark “(3)”, and the liquidus temperature (i.e., the upper limit temperature of a devitrification range) of each of these glasses is indicated by the mark “∘”. The devitrification range is on the lower temperature side of the mark “∘”.

The conventional glass indicated by the mark “(1)” exhibits low-viscosity characteristics over a wide temperature range from low to high temperatures, and therefore the molten glass is not formed into droplets but is formed into a continuous laminar flow like tap water flowing from a faucet. If the temperature of the nozzle is decreased to increase the viscosity of the molten glass to form glass droplets, the temperature of the molten glass is decreased to its liquidus temperature or less so that a devitrification phenomenon occurs.

The conventional glass indicated by the mark “(2)” exhibits high-viscosity characteristics even at a high temperature, and therefore glass droplets are formed by cutting the stream of the molten glass by a cutting means such as a blade or shears. In order to allow the molten glass to have an appropriate viscosity, it is necessary to heat the melting furnace 1 and the nozzle 2 to a very high temperature, which causes problems in heat resistance and durability of the melting furnace 1 and the like.

On the other hand, the glass according to the present invention indicated by the mark “(3)” has a temperature-viscosity curve suitable for forming glass droplets. The present inventors have considered that there is a certain relationship between the temperature and viscosity of molten glass and the suitability of the molten glass for formation of glass droplets, and have produced various types of glasses to examine the relationship between the temperature and viscosity of each molten glass and the suitability of the molten glass for formation of glass droplets.

### EXAMPLES

As shown in Table 1, various types of glasses were produced to examine the relationship between the temperature and viscosity of each molten glass and the suitability of the molten glass for formation of glass droplets. It is to be noted that in Table 1, glasses A to G are examples of the present invention and glasses α and β are conventional glasses prepared as comparative examples.

In a melting furnace, a glass was melted using a platinum crucible at a temperature of 1,200 to 1,400° C. to obtain molten glass. The molten glass was cooled to a predetermined temperature at a rate of −100° C./hr, and was maintained at the predetermined temperature for 12 hours. Then, the molten glass was cast into a mold and cooled to room temperature, and a lower limit of a temperature at which no devitrification (crystallization) was observed in the glass was defined as a liquidus temperature. At this time, the interior of the glass was observed at 100×magnification using an optical microscope BX50 manufactured by Olympus Corporation. Further, the viscosity of the glass was measured using a high-temperature viscometer TVB-20H manufactured by ADVANTEST Corporation.

A viscosity index (A) was defined as a value obtained by dividing the viscosity of a glass at the liquidus temperature thereof by the liquidus temperature of the glass, and the viscosity index (A) of each of the glasses was calculated. Further, each of the glasses A to G (i.e., glasses according to the present invention) and glasses α and β (i.e., glasses of the comparative examples) was fed into the melting furnace 1 of the apparatus for producing a glass gob 14 shown in FIG. 1 to examine whether or not molten glass droplets 12 could be formed.

TABLE 1

| | | viscosity | | suitability |
|---|---|---|---|---|
| | liquidus | at liquidus | | for forming |
| | temperature | temperature | viscosity | glass |
| | (° C.) | (poise) | index A | droplets |
| fluoride | 1200 | 0.5 | 0.000417 | suitable |
| glass A | | | | |
| oxide | 1100 | 1.7 | 0.001545 | suitable |
| glass B | | | | |
| oxide | 1000 | 2.5 | 0.002500 | suitable |
| glass C | | | | |
| oxide | 900 | 8.2 | 0.009111 | suitable |
| glass D | | | | |
| oxide | 800 | 18 | 0.022500 | suitable |
| glass E | | | | |
| oxide | 750 | 330 | 0.440000 | suitable |
| glass F | | | | |
| oxide | 700 | 1040 | 1.485714 | suitable |
| glass G | | | | |
| fluoride | 1200 | 0.3 | 0.000250 | not |
| glass α | | | | suitable |
| oxide | 700 | 1100 | 1.571429 | not |
| glass β | | | | suitable |

As can be seen from Table 1, all the molten glasses A to G having a viscosity index (A) in the range of 0.0004 to 1.5 were naturally dropped intermittently and regularly to form glass droplets 12. On the other hand, the molten glass α whose viscosity index A was not in the range of 0.0004 to 1.5 was too soft (that is, the viscosity of the molten glass α was too low) to be formed into glass droplets, and the molten glass β was too hard (that is, the viscosity of the molten glass β was too high) to be formed into glass droplets.

The thus obtained glass droplet 12 was received by a concave molding surface 22 of a ceramic receiving mold 20. The receiving mold 20 was heated to a temperature in the vicinity of the glass transition point. The glass droplet 12 received in the receiving mold 20 formed a glass gob 14. The top surface of the glass gob 14 was a free surface, and the lower surface thereof had a shape transferred from the molding surface 22. The thus obtained glass gob 14 had no defect such as a shear mark, and therefore there was no necessity to carry out aftertreatment for eliminating a defect such as a shear mark, thereby reducing the production cost of the glass gob 14.

After once cooled to room temperature, such a glass gob 14 could be used as a preform for reheating molding by again heating it.

As has been described above, a molten glass whose viscosity index (A) determined by the relationship between the viscosity of the glass at the liquidus temperature thereof and the liquidus temperature of the glass is in the range of 0.0004 to 1.5 is naturally dropped from the nozzle of the melting furnace by gravitation intermittently and regularly to form glass droplets having a certain volume. Here, the term “liquidus temperature” means an upper limit temperature at which crystallization, that is, devitrification occurs.

If the viscosity index (A) is less than 0.0004, the molten glass is too soft (that is, the viscosity of the molten glass is too low) to be formed into glass droplets having a certain volume, and therefore a stream of the molten glass flows continuously from the nozzle. On the other hand, if the viscosity index (A) exceeds 1.5, the molten glass is too hard (that is, the viscosity of the molten glass is too high), and therefore it is necessary to cut the stream of the molten glass with some kind of cutting means to form glass droplets.

A glass preform formed from the glass droplet has no defect such as a shear mark, and therefore there is no necessity to carry out aftertreatment for eliminating a defect such as a shear mark, thereby reducing the production cost of the glass preform.

Further, an optical glass element (e.g., a lens or a prism) having no plane defect such as a shear mark could be produced by press-molding a hot glass gob 14 with an upper mold just after the glass gob 14 was received by the receiving mold 20. Such an optical glass element (e.g., a lens or a prism) having no plane defect such as a shear mark could also be produced by transporting a glass gob 14 received on the receiving mold 20 onto another lower mold and press-molding the glass gob 14 with a pair of upper and lower molds.

It is to be noted that the present invention can be applied to various glass production fields, but in the case of producing optical elements such as lenses and prisms, oxide glasses and fluoride glasses having the viscosity index (A) within the above described range are preferably used.

Although the present invention has been fully described by way of examples with reference to the accompanying drawings, it is to be noted that various changes and modifications will be apparent to those skilled in the art. Therefore, unless such changes and modification depart from the scope of the present invention, they should be constructed as being included therein.

What is claimed is:

1. A glass whose viscosity index defined as a value obtained by dividing the viscosity of the glass at the liquidus temperature thereof by the liquidus temperature of the glass is in the range of 0.0004 to 1.5.

2. A glass according to claim 1, wherein the glass is an oxide glass.

3. A glass according to claim 1, wherein the glass is a fluoride glass.

4. A glass preform manufactured by a method where a droplet of the glass according to claim 1 is received by a mold.

5. A glass optical element manufactured by a method where a droplet of the glass according to claim 1 is received by a receiving mold, and the droplet is pressed by the receiving mold and an upper mold.
